(19) United States
(12) Patent Application Publication
(10) Pub. No.: US 2006/0024490 A1
(43) Pub. Date: Feb. 2, 2006

(54) Metal matrix composites, and methods for making the same

(75) Inventors: Paul S. Werner, Woodbury, MN (US); Michael F. Grether, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/902,382

(22) Filed: Jul. 29, 2004

(51) Int. Cl. B22D 19/14; B22D 19/00; B32B 5/16

(52) U.S. Cl. 428/323; 164/97; 164/98

(57) ABSTRACT

Metal matrix composite inserts and articles, and methods for making the same.

### BACKGROUND

In general, the reinforcement of metal matrices with ceramics is known in the art (see, e.g., U.S. Pat. No. 4,705,093 (Ogino), U.S. Pat. No. 4,852,630 (Hamajima et al.), U.S. Pat. No. 4,932,099 (Corwin et al.), U.S. Pat. No. 5,199,481 (Corwin et al.), U.S. Pat. No. 5,234,080 (Pantale) and U.S. Pat. No. 5,394,930 (Kennerknecht), and Great Britain Pat. Doc. Nos. 2,182,970 A and B, published May 28, 1987 and Sep. 14, 1988, respectively). Examples of ceramic materials used for reinforcement include particles, discontinuous fibers (including whiskers) and continuous fibers, as well as ceramic pre-forms.

One exemplary form of metal matrix composites are wires of a metal (e.g., aluminum) reinforced with continuous ceramic oxide fibers (e.g., ceramic oxide fibers marketed by 3M Company, St. Paul, Minn. under the trade designation “NEXTEL”) in the longitudinal direction (see, e.g., U.S. Pat. No. 6,180,232 (McCullough et al.), U.S. Pat. No. 6,245,425 (McCullough et al.), U.S. Pat. No. 6,336,495 (McCullough et al.), U.S. Pat. No. 6,329,056 (Deve et al.), U.S. Pat. No. 6,344,270 (McCullough et al.), U.S. Pat. No. 6,447,927 (McCullough et al.), and U.S. Pat. No. 6,460,597 (McCullough et al.), U.S. Pat. No. 6,544,645 (McCullough et al.), and PCT application having Publication No. WO02/06550, published Jan. 24, 2002). Such wires are used, for example in overhead power transmission cables.

Another exemplary form of metal matrix composite are inserts for reinforcing larger constructions, wherein the inserts comprise a metal (e.g., aluminum) reinforced with continuous ceramic oxide fibers (e.g., ceramic oxide fibers marketed by 3M Company under the trade designation “NEXTEL”) in the longitudinal direction (see, e.g., PCT Applications having Publication Nos. WO2004/018718, WO2004/018725, and WO2004/018726, published Mar. 4, 2004).

In another aspect, it has been suggested that fiber reinforced aluminum wires could be used as semi-finished materials for fabricating larger aluminum (including aluminum alloy) metal matrix composite articles by consolidation into structural shapes through various processes, including diffusion bonding, hot-pressing, sintering, or brazing.

### SUMMARY

In one aspect, the present invention provides a method for making metal matrix composite inserts and metal matrix composite articles reinforced with metal matrix composite insert(s) (e.g., one, two, three, four, five, six, or more inserts).

One embodiment of a method according to the present invention for making a metal matrix composite comprises:
consolidating a three dimensional array of elongated metal matrix composite articles (e.g., metal matrix composite wires) together to provide a metal matrix composite insert, the metal matrix composite insert having an outer surface,
   wherein at least three of the elongated metal matrix composite articles each comprise a plurality of substantially continuous fibers selected from the group consisting of boron fibers, boron nitride fibers, carbon fibers, ceramic oxide fibers, graphite fibers, silicon carbide fibers, and combinations thereof in a metal selected from the group consisting of aluminum, magnesium, and alloys thereof (e.g., a 200, 300, 400, 700, and/or 6000 series aluminum alloy), wherein the metal secures the substantially continuous fibers in place, and wherein the metal extends along at least a portion of the length of the substantially continuous fibers, and
   wherein the metal matrix composite insert comprises the substantially continuous fibers and metal of the elongated metal matrix composite articles, wherein such metal secures the substantially continuous fibers in place, wherein at least 50 (in some embodiments, at least 60, 65, 70, or even, at least 75; in some embodiments, in a range from 50 to 70, or 55 to 65) percent by volume of the metal matrix composite insert are the substantially continuous fibers, wherein such metal extends along at least a portion of the length of the substantially continuous fibers (and wherein the metal matrix composite insert has an outer surface).
      In this application, “consolidating” means applying sufficient heat and pressure to the three dimensional array of elongated metal matrix composite articles to provide the metal matrix composite insert.

Optionally, in some embodiments, the method further comprises providing a metal layer onto the outer surface of the metal matrix composite insert. In some embodiments, the method further comprises providing a metal layer having a positive Gibbs oxidation free energy at a temperature above at least 200° C. (e.g., silver, gold, alloys thereof, and combinations thereof) onto the outer surface of the metal matrix composite insert, wherein in some embodiments, the metal layer has a thickness of at least 8 micrometers (in some embodiments, at least 10 micrometers, at least 12 micrometers, or even at least 15 micrometers, and typically less than 20 micrometers; in some embodiments, in the range from 12 to 15 micrometers). The phrase “Positive Gibbs Oxidation Free Energy At A Temperature Above At Least 200° C.” refers to the quantity ΔG⁰ᵣₓₙ=ΔH⁰ᵣₓₙ−TΔS⁰ᵣₓₙ, where ΔH⁰ᵣₓₙ is the enthalpy of the oxidation reaction in kJ/mol, T is the temperature in degrees Kelvin, and ΔS⁰ᵣₓₙ is the entropy of the oxidation reaction (in kJ/mol ° K) remaining positive for temperatures greater than 200° C. (473° K).

In some embodiments, the method further comprises providing at least one of a zinc or tin layer onto the outer surface of the metal matrix composite insert. In embodiments where the method further comprises providing the metal layer having a positive Gibbs oxidation free energy at a temperature above at least 200° C., the method optionally further comprises providing at least one of a nickel, zinc, or tin layer between the metal layer having a positive Gibbs oxidation free energy at a temperature above at least 200° C. and the aluminum, magnesium, and/or alloys thereof. Typically, if both (a) the nickel and (b) the zinc and/or tin are present, the order of the metals is (i) the zinc and/or tin, (ii) the nickel, and (iii) the metal having a positive Gibbs oxidation free energy at a temperature above at least 200° C. In some embodiments, the substantially continuous fibers include substantially continuous ceramic oxide fibers and the metal of the elongated metal matrix composite articles each is selected from the group consisting of aluminum and alloys thereof (e.g., a 200, 300, 400, 700, and/or 6000 series aluminum alloy).

One embodiment of a metal matrix composite reinforcement insert according to the present invention comprises:
substantially continuous fibers and a metal, wherein the metal secures the substantially continuous fibers in place, wherein at least 50 (in some embodiments, at least 60, 65, 70, or even, at least 75; in some embodiments, in a range from 50 to 70, or 55 to 65) percent by volume of the metal matrix composite insert are the substantially continuous fibers, wherein the metal extends along at least a portion of the length of the substantially continuous fibers, wherein the substantially continuous fibers are selected from the group consisting of boron fibers, boron nitride fibers, carbon fibers, ceramic oxide fibers, graphite fibers, silicon carbide fibers, and combinations thereof, wherein the metal is selected from the group consisting of aluminum, magnesium, and alloys thereof (e.g., a 200, 300, 400, 700, and/or 6000 series aluminum alloy), wherein the metal matrix composite reinforcement insert includes a microstructure comprising a plurality of generally polygonal (e.g., hexagonal) shapes, wherein for at least some of the generally polygonal shapes, each generally polygonal shape generally shares a common vertex with at least two adjacent generally polygonal shapes (as determined from a polished cross-section of the metal matrix composite reinforcement insert at 25× magnification as described in the Example) (wherein it is understood that a vertex may not necessarily be a precise point (e.g., it may be rounded)).

Optionally in some embodiments, the insert further comprises a metal layer onto the outer surface of the insert. In some embodiments, the insert further comprises a metal layer having a positive Gibbs oxidation free energy at a temperature above at least 200° C. (e.g., silver, gold, alloys thereof, and combinations thereof) onto the outer surface of the insert, wherein in some embodiments, the metal layer has a thickness of at least 8 micrometers (in some embodiments, at least 10 micrometers, at least 12 micrometers, or even at least 15 micrometers, and typically less than 20 micrometers; in some embodiments, in the range from 12 to 15 micrometers). Optionally, in some embodiments, the insert further comprises at least one of a zinc or tin layer onto the outer surface of the insert. In embodiments where the insert further comprises the metal layer having a positive Gibbs oxidation free energy at a temperature above at least 200° C., the insert optionally further comprises at least one of a nickel, zinc, or tin layer between the metal layer having a positive Gibbs oxidation free energy at a temperature above at least 200° C. and the aluminum, magnesium, and/or alloys thereof. Typically, if both the (a) nickel and (b) zinc and/or tin are present, the order of the metals is (i) zinc and/or tin and (ii) nickel, and (iii) the metal having a positive Gibbs oxidation free energy at a temperature above at least 200° C. In some embodiments, the substantially continuous fibers include substantially continuous ceramic oxide fibers and the metal of the metal matrix is selected from the group consisting of aluminum and alloys thereof (e.g., a 200, 300, 400, 700, and/or 6000 series aluminum alloy).

In some embodiments of metal matrix composite articles according to the present invention (including those made according to the present invention), the metal matrix composite articles have very desirable bonding between the insert(s) and the metal of the metal matrix composite article comprising the insert(s) (e.g., in some embodiments, a bond interface free of oxide (i.e., no visibly discernible continuous oxide layer at the interface (polished as described in the Example, below) when viewed at 100× with an optical microscope) and/or a peak bond strength value as determined by the “Peak Bond Strength” test described below) of at least 100 MPa (in some embodiments, at least 125 MPa, at least 150 MPa, at least 175 MPa, or even at least 180 MPa)). Although not wanting to be bound by theory, it is believed that the presence of metal having a positive Gibbs oxidation free energy at a temperature above at least 200° C. aids to facilitate obtaining the bonding between the insert(s) and the metal of the metal matrix composite article comprising the insert(s). Further, although not wanting to be bound by theory, it is believed that the presence of zinc, tin, or metal having a positive Gibbs oxidation free energy at a temperature above at least 200° C. aids to facilitate the absence of oxides at the interface between the insert(s) and the metal of the metal matrix composite article comprising the insert(s).

In some embodiments of methods according to the present invention, the consolidating is conducted at a pressure less than 40 MPa (in some embodiments, less than 30 MPa; in some embodiments, in a range from 4 MPa to 30 MPa). Typically, the metal matrix composite articles each have an outer metal region, wherein the consolidating includes heating at least a portion of the outer regions of the elongated metal matrix composite articles at least partially melts. In some embodiments, the metal matrix composite insert is encased in the resulting cooled metal.

In some embodiments, the substantially continuous fibers present in the metal matrix composite inserts are longitudinally positioned. In some embodiments, the metal matrix composite inserts have a transverse strength of at least 275 MPa, 345 MPa, 415 MPa, or even at least 475 MPa (in some embodiments, in a range from 275 MPa to 475 MPa). In some embodiments, the metal matrix composite inserts have a longitudinal tensile strength of at least 1.3 GPa, or even at least 2 GPa (in some embodiments, in a range from 1.3 GPa to 2 GPa).

One embodiment of a method of making a metal matrix composite article comprises:
positioning a metal matrix composite reinforcement insert according to the present invention in a mold;
providing molten metal selected from the group consisting of aluminum and alloys thereof (e.g., a 200, 300, 400, 700, and/or 6000 series aluminum alloy) into the mold; and
cooling the molten metal to provide a metal matrix composite article.

### BRIEF DESCRIPTION OF THE DRAWING

FIG. 1 is a perspective view of an exemplary metal matrix composite insert according to the present invention.

FIG. 2 is a perspective view of another exemplary metal matrix composite insert according to the present invention.

FIG. 3 is a schematic of an exemplary ultrasonic apparatus used to infiltrate fibers with molten metals and provide elongated metal matrix composite articles.

FIGS. 4A and 4B are schematics of an exemplary apparatus used to consolidate elongated metal matrix composite articles and provide elongated metal matrix composite inserts according to the present invention.

FIG. 5 is a perspective view of an exemplary insert holder. FIG. 5A is a cutaway view of a portion of FIG. 5.

FIG. 6 is a schematic of the compressive shear test equipment used to determine the peak bond strength value between an insert and the metal of a metal matrix composite article.

FIGS. 7A and 7B are perspective views of an exemplary brake caliper according to the present invention. FIGS. 7C and 7D are cross-sectional views of the brake caliper shown in FIGS. 7A and 7B.

FIGS. 8A and 8B are plan views of another exemplary brake caliper according to the present invention.

FIG. 9 is a perspective view of another exemplary brake caliper according to the present invention.

FIG. 10 is a plan view of a foil pattern useful for practicing a method of the present invention.

FIG. 11A is an optical photomicrograph at 25× of a polished cross-section of the metal matrix composite insert in the Example.

FIG. 11B is a schematic of the polished cross-section shown in FIG. 11A.

FIG. 12 is an optical photomicrograph at 25× of a polished cross-section of the Comparative Example metal matrix composite insert.

FIG. 13 is a schematic of an apparatus for used to determine transverse tensile strength of an insert according to the present invention.

FIG. 14 is an optical photomicrograph at 100× of the polished cross-section of the metal matrix composite insert in the Example.

### DETAILED DESCRIPTION

Typically, metal matrix composite inserts and articles according to the present invention are designed for the particular application to achieve an optimal, or at least acceptable, balance of desired properties, low cost, and/or ease of manufacture.

Typically, metal matrix composite inserts and articles according to the present invention are designed for a specific application and/or to have certain properties and/or features. For example, an existing article made of a first metal (e.g., cast iron) is selected to be redesigned to be made from another metal (e.g., aluminum) reinforced with material including substantially continuous fibers such that the latter (i.e., the metal matrix composite version of the article) has certain desired properties (e.g., Young's modulus, yield strength, and ductility) at least equal to that required for the use of the original article made from the first metal. Optionally, the article may be redesigned to have the same physical dimensions as the original article.

The desired metal matrix composite article configuration, desired properties, possible metals and fibers from which it may be desirable for it to be made of, as well as properties of those materials are typically used to provide possible suitable constructions. In some embodiments, a technique for generating possible constructions utilizes finite element analysis (FEA), including the use of FEA software run with the aid of a conventional computer system (including the use of a central processing unit (CPU) and input and output devices). Suitable FEA software is commercially available, including that marketed by Ansys, Inc., Canonsburg, Pa. under the trade designation “ANSYS”. FEA assists in modeling the article mathematically and identifying regions where placement of the continuous ceramic oxide fibers, metal(s), and possibly other materials would provide the desired property levels. It is typically necessary to run several iterations of FEA to obtain a more desirable design.

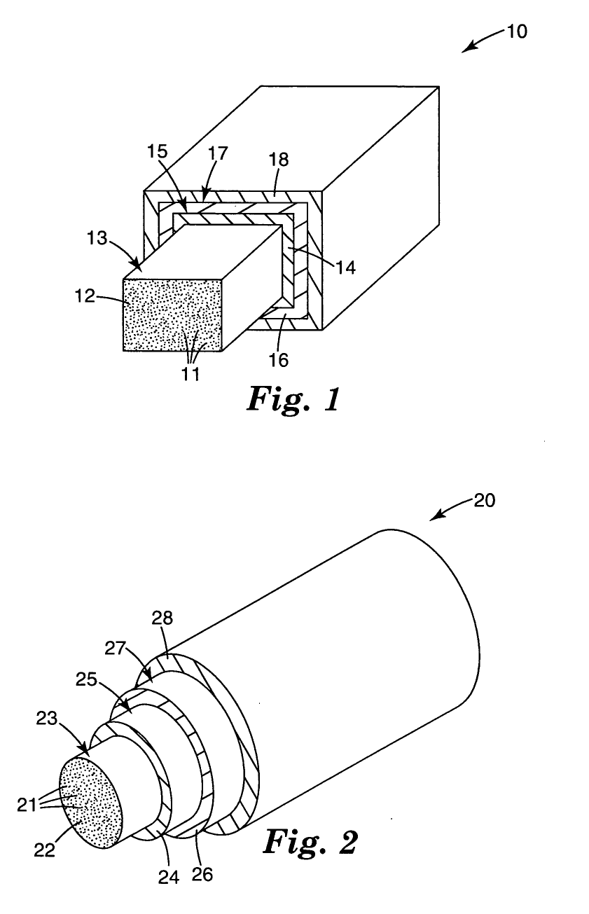

Referring to FIG. 1, exemplary metal matrix composite insert according to the present invention 10 comprises substantially continuous fibers 11, metal 12, outer surface 13, at least one of zinc or tin 14, outer surface 15, nickel 16, outer surface 17, and metal having a positive Gibbs oxidation free energy at a temperature above at least 200° C. 18. Metal matrix composite insert 10 is useful for making metal matrix composite articles according to the present invention.

In some embodiments, inserts comprise the substantially continuous fibers, in the range from 30 to 50 percent (in some embodiments, 30 to 55 percent, or even 40 to 70 percent) by volume metal and in the range from 70 to 50 percent (in some embodiments, 70 to 45 percent, or even 60 to 30 percent) by volume substantially continuous fibers, based on the total volume of the insert.

Embodiments of suitable metal matrix composite articles (e.g., metal matrix composite wires) for practicing the present invention are known in the art, and include those disclosed, for example, in U.S. Pat. No. 6,180,232 (McCullough et al.), U.S. Pat. No. 6,245,425 (McCullough et al.), U.S. Pat. No. 6,336,495 (McCullough et al.), U.S. Pat. No. 6,329,056 (Deve et al.), U.S. Pat. No. 6,344,270 (McCullough et al.), U.S. Pat. No. 6,447,927 (McCullough et al.), and U.S. Pat. No. 6,460,597 (McCullough et al.), U.S. Pat. No. 6,485,796 (Carpenter et al.), U.S. Pat. No. 6,544,645 (McCullough et al.); U.S. application having Ser. No. 09/616,741, filed Jul. 14, 2000; and PCT application having Publication No. WO02/06550, published Jan. 24, 2002.

Substantially continuous fibers for making the metal matrix composite articles for practicing the present invention include ceramic fibers, such as metal oxide (e.g., alumina) fibers, boron fibers, boron nitride fibers, graphite fibers, and silicon carbide fibers. Typically, the ceramic oxide fibers are crystalline ceramics and/or a mixture of crystalline ceramic and glass (i.e., a fiber may contain both crystalline ceramic and glass phases). “Substantially continuous fiber” means a fiber having a length that is relatively infinite when compared to the average fiber diameter. Typically, with regard to the present invention, the substantially continuous fibers have lengths of at least 5 cm (in some embodiments, at least 10 cm, 15 cm, 20 cm, or even at least 25 cm; in some embodiments, in a range from 5 to 25 cm).

Typically, the substantially continuous reinforcing fibers have an average fiber diameter of at least about 5 micrometers. Typically, the average fiber diameter is no greater than about 50 micrometers, more typically, no greater than about 25 micrometers (in some embodiments, in a range from 8 micrometers to 20 micrometers, 10 micrometers to 15 micrometers, or even 10 micrometers to 12 micrometers).

In some embodiments, the ceramic fibers have an average tensile strength of at least 1.4 GPa (in some embodiments, at least 1.5 GPa, 2 GPa, 2.5 GPa, or even at least 2.8 GPa). In some embodiments, the carbon fibers have an average tensile strength of at least 1.4 GPa (in some embodiments, at least 1.5 GPa, 2 GPa, 2.5 GPa, or even at least 5.5 GPa).

In some embodiments, the fibers have a Young's modulus of no greater than about 1000 GPa (in some embodiments, no greater than 500 GPa, 450 GPa, 420 GPa, 400 GPa, 350 GPa, 250 GPa, 200 GPa, 150 GPa, 100 GPa, or even, no greater than 70 GPa).

In some embodiments, at least a portion of the substantially continuous ceramic oxide fibers used to make the metal matrix composite inserts are in tows. Tows are well known in the fiber art and refer to a plurality of (individual) fibers (typically at least 100 fibers, more typically at least 400 fibers) collected in a rope-like form. In some embodiments, tows comprise at least 780 individual fibers per tow, or even, for example, at least 2600 individual fibers per tow. Tows of ceramic fibers are available in a variety of lengths, including 300 meters and longer. Typically, the fibers have a cross-sectional shape that is circular or elliptical.

Exemplary alumina fibers are known in the art and include those disclosed in U.S. Pat. No. 4,954,462 (Wood et al.). In some embodiments, the alumina fibers are polycrystalline alpha alumina-based fibers and comprise, on a theoretical oxide basis, greater than about 99 percent by weight Al₂O₃ and about 0.2 to about 0.5 percent by weight SiO₂, based on the total weight of the alumina fibers. In another aspect, in some embodiments, polycrystalline, alpha alumina-based fibers comprise alpha alumina having an average grain size of less than 1 micrometer (in some embodiments, less than 0.5 micrometer). In another aspect, in some embodiments, polycrystalline, alpha alumina-based fibers have an average tensile strength of at least 1.6 GPa (in some embodiments, at least 2.1 GPa, or even at least 2.8 GPa). Exemplary alpha alumina fibers are commercially available under the trade designation “NEXTEL 610” from 3M Company of St. Paul, Minn.

Exemplary aluminosilicate fibers include those disclosed in U.S. Pat. No. 4,047,965 (Karst et al.). In some embodiments, the aluminosilicate fibers comprise, on a theoretical oxide basis, in the range from about 67 to about 85 (in some embodiments, about 67 to about 77) percent by weight Al₂O₃ and in the range from about 33 to about 15 (in some embodiments, about 33 to about 23) percent by weight SiO₂, based on the total weight of the aluminosilicate fibers. One exemplary aluminosilicate fiber comprises, on a theoretical oxide basis, about 85 percent by weight Al₂O₃ and about 15 percent by weight SiO₂, based on the total weight of the aluminosilicate fibers. Another exemplary aluminosilicate fiber comprises, on a theoretical oxide basis, about 73 percent by weight Al₂O₃ and about 27 percent by weight SiO₂, based on the total weight of the aluminosilicate fibers. Exemplary aluminosilicate fibers are commercially available under the trade designations “NEXTEL 440” ceramic oxide fibers, “NEXTEL 550” ceramic oxide fibers, and “NEXTEL 720” ceramic oxide fibers from 3M Company.

Exemplary aluminoborosilicate fibers include those disclosed in U.S. Pat. No. 3,795,524 (Sowman). In some embodiments, the aluminoborosilicate fibers comprise, on a theoretical oxide basis: about 35 percent by weight to about 75 percent by weight (in some embodiments, about 55 percent by weight to about 75 percent by weight) Al₂O₃; greater than 0 percent by weight (in some embodiments, at least about 15 percent by weight) and less than about 50 percent by weight (in some embodiments, less than about 45 percent, and in some embodiments, less than about 44 percent) SiO₂; and greater than about 5 percent by weight (in some embodiments, less than about 25 percent by weight; in some embodiments, about 1 percent by weight to about 5 percent by weight, or even about 10 percent by weight to about 20 percent by weight) B₂O₃, based on the total weight of the aluminoborosilicate fibers. Exemplary aluminoborosilicate fibers are commercially available under the trade designation “NEXTEL 312” from 3M Company.

Exemplary boron fibers are commercially available, for example, from Specialty Fibers, Inc. of Lowell, Mass.

Boron nitride fibers can be made, for example, as described in U.S. Pat. No. 3,429,722 (Economy) and U.S. Pat. No. 5,780,154 (Okano et al.).

Exemplary carbon fibers are commercially available, for example, from BP Amoco Chemicals of Alpharetta, Ga. under the trade designation “THORNEL CARBON” in tows of 2000, 4000, 5000, and 12,000 fibers, Hexcel Corporation of Stamford, Conn., from Grafil, Inc. of Sacramento, Calif. (subsidiary of Mitsubishi Rayon Co.) under the trade designation “PYROFIL”, Toray of Tokyo, Japan, under the trade designation “TORAYCA”, Toho Rayon of Japan, Ltd. under the trade designation “BESFIGHT”, Zoltek Corporation of St. Louis, Mo. under the trade designations “PANEX” and “PYRON”, and Inco Special Products of Wyckoff, N.J. (nickel coated carbon fibers), under the trade designations “12K20” and “12K50”.

Exemplary graphite fibers are commercially available, for example, from BP Amoco of Alpharetta, Ga. under the trade designation “T-300” in tows of 1000, 3000, and 6000 fibers.

Exemplary silicon carbide fibers are commercially available, for example, from COI Ceramics of San Diego, Calif. under the trade designation “NICALON” in tows of 500 fibers, from Ube Industries of Japan, under the trade designation “TYRANNO”, and from Dow Corning of Midland, Mich. under the trade designation “SYLRAMIC”.

Some commercially available fibers include an organic sizing material added to the fiber during their manufacture to provide lubricity and to protect the fiber strands during handling. It is believed that the sizing tends to reduce the breakage of fibers, reduces static electricity, and reduces the amount of dust during, for example, conversion to a fabric. The sizing can be removed, for example, by dissolving or burning it away. In some embodiments, the sizing is removed before forming the elongated metal matrix composite article. In this way, before forming the elongated metal matrix composite article the fibers are free of any sizing thereon.

It is also within the scope of the present invention to have coatings on the fibers. Coatings may be used, for example, to enhance the wettability of the fibers, and/or to reduce or prevent reaction between the fibers and molten metal matrix material. Such coatings and techniques for providing such coatings are known in the fiber and metal matrix composite art.

Typically, the metal of the metal matrix composite is selected such that the matrix material does not significantly react chemically with the fiber material (i.e., is relatively chemically inert with respect to fiber material). The metals for the metal matrix composite articles materials selected from the group consisting of aluminum, magnesium, and alloys thereof (e.g., an alloy of aluminum and copper (in some embodiments, at least about 98 percent by weight Al and up to about 2 percent by weight Cu)). In some embodiments, the metal comprises at least 98 percent by weight aluminum (in some embodiments, at least 99, 99.9, or even greater than 99.95 percent by weight aluminum). In some embodiments, useful alloys are 200, 300, 400, 700, and/or 6000 series aluminum alloy. Although higher purity metals tend to be more desirable for making higher tensile strength elongated metal matrix composite articles, less pure forms of metals are also useful.

Suitable metals are commercially available. For example, aluminum is available under the trade designation “SUPER PURE ALUMINUM; 99.99% Al” from Alcoa, Pittsburgh, Pa. Aluminum alloys (e.g., Al-2% by weight Cu (0.03% by weight impurities)) can be obtained, for example, from Belmont Metals, New York, N.Y. For example, magnesium is available under the trade designation “PURE” from Magnesium Elektron, Manchester, England. Magnesium alloys (e.g., WE43A, EZ33A, AZ81A, and ZE41A) can be obtained, for example, from TIMET, Denver, Colo.

Typically, at least about 85% by number of the fibers in the elongated metal matrix articles are substantially continuous. In some embodiments, and typically, the fibers in the elongated metal matrix articles are longitudinally positioned (i.e., the fibers are oriented in the same direction as the length of the respective elongated metal matrix articles). In some embodiments, it is desirable that all of the continuous fibers are maintained in an essentially longitudinally aligned configuration where individual fiber alignment is maintained within ±10° (in some embodiments ±5°, or even ±3°) of their average longitudinal axis.

For some metal matrix composite articles according to the present invention, it may be desirable or necessary for the substantially continuous fibers to be curved, as opposed to straight (i.e., do not extend in a planar manner). For example, the substantially continuous fibers may be planar throughout the fiber length, non-planar (i.e., curved) throughout the fiber length, or they may be planar at some portions and non-planar (i.e., curved) at other portions. In some embodiments, the substantially continuous fibers are maintained in a substantially non-intersecting, curvilinear arrangement (i.e., longitudinally aligned) throughout the curved portion of the metal matrix composite insert. In some embodiments, the substantially continuous fibers are maintained in a substantially equidistant relationship with each other throughout the curved portion of the metal matrix composite insert.

For example, in FIG. 2 exemplary metal matrix composite insert 20 is according to the present invention, wherein metal matrix composite insert 20 comprises substantially continuous fibers 21, metal 22, outer surface 23, at least one of zinc or tin 24, outer surface 25, nickel 26, outer surface 27, and metal having a positive Gibbs oxidation free energy at a temperature above at least 200° C. 28.

Exemplary dimensions of the elongated metal matrix articles include a cross-sectional dimension of at least 0.2 mm, 1 mm, or even at least 2 mm; in some embodiments, in a range from 0.2 mm to 3.5 mm. Exemplary dimensions of the elongated metal matrix wires include those having diameters of at least 0.2 mm, 0.5 mm, 1 mm, or even at least 2 mm; in some embodiments, in a range from 0.2 mm to 3.5 mm. In another aspect, some exemplary elongated metal matrix articles have an average tensile strength of at least 0.5 GPa (in some embodiments, at least 1 GPa).

The particular fibers, metal, and process steps for making the elongated metal matrix composite articles are selected to provide the elongated metal matrix composite articles with the desired properties. For example, the fibers and metal are selected to be sufficiently compatible with each other and the elongated metal matrix composite article fabrication process in order to make the desired elongated metal matrix composite article. Additional details regarding exemplary techniques for making elongated metal matrix composite articles are disclosed, for example, in U.S. Pat. No. 6,180,232 (McCullough et al.), U.S. Pat. No. 6,245,425 (McCullough et al.), U.S. Pat. No. 6,336,495 (McCullough et al.), U.S. Pat. No. 6,329,056 (Deve et al.), U.S. Pat. No. 6,344,270 (McCullough et al.), U.S. Pat. No. 6,447,927 (McCullough et al.), and U.S. Pat. No. 6,460,597 (McCullough et al.), U.S. Pat. No. 6,485,796 (Carpenter et al.), U.S. Pat. No. 6,544,645 (McCullough et al.); U.S. application having Ser. No. 09/616,741, filed Jul. 14, 2000; and PCT application having Publication No. WO02/06550, published Jan. 24, 2002.

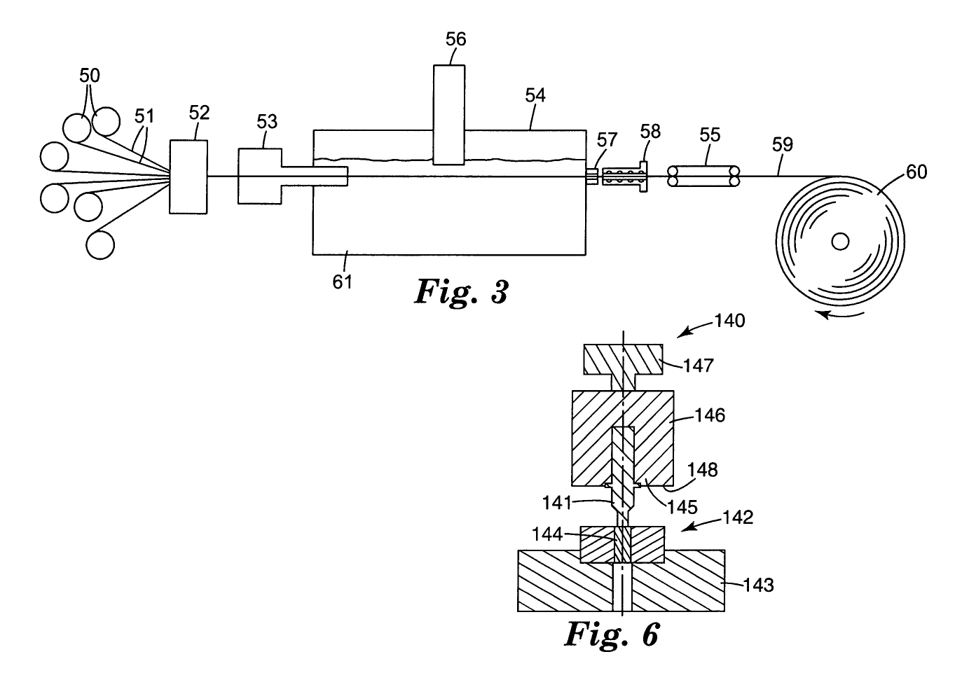

Typically, the elongated metal matrix composite articles (e.g., wires) can be made, for example, by a continuous metal matrix infiltration processes. A schematic of an exemplary apparatus for making elongated metal matrix composite articles (e.g., wires) is shown in FIG. 3. Tows of substantially continuous fibers 51 are supplied from supply spools 50, and are collimated into a circular bundle and heat-cleaned while passing through tube furnace 52. The fibers are then evacuated in vacuum chamber 53 before entering crucible 54 containing the melt of metallic matrix material 61 (also referred to herein as “molten metal”). The fibers are pulled from supply spools 50 by caterpuller 55. Ultrasonic probe 56 is positioned in the melt in the vicinity of the fiber to aid in infiltrating the melt into tows 51. The molten metal of the wire cools and solidifies after exiting crucible 54 through exit die 57, although some cooling may occur before it fully exits crucible 54. Cooling of wire 59 is enhanced by streams of gas or liquid 58 from a fluid dispenser. Wire 59 is collected onto spool 60.

As discussed above, heat-cleaning the fiber aids in removing or reducing the amount of sizing, adsorbed water, and other fugitive or volatile materials that may be present on the surface of the fibers. For example, in some embodiments, the fibers are heat-cleaned until the carbon content on the surface of the fiber is less than 22% area fraction. Typically, the temperature of the tube furnace is at least about 300° C., more typically, at least 1000° C. for at least several seconds at temperature, although the particular temperature(s) and time(s) will depend, for example, on the cleaning needs of the particular fiber being used.

In some embodiments, the fibers are evacuated before entering the melt, as it has been observed that the use of such evacuation tends to reduce or eliminate the formation of defects such as localized regions with dry fibers. In some embodiments, the fibers are evacuated in a vacuum of not greater than 20 Torr (in some embodiments, not greater than 10 Torr, 1 Torr, or even not greater than 0.7 Torr).

An example of a suitable vacuum system is an entrance tube sized to match the diameter of the bundle of fiber. The entrance tube can be, for example, a stainless steel or alumina tube, and is typically at least 30 cm long. One exemplary vacuum chamber typically has a diameter in the range from about 2 cm to about 20 cm, and a length in the range from about 5 cm to about 100 cm. In some embodiments, the capacity of the vacuum pump is at least about 0.2 to about 0.4 cubic meters/minute. The evacuated fibers are inserted into the melt through a tube on the vacuum system that penetrates the aluminum bath (i.e., the evacuated fibers are under vacuum when introduced into the melt), although the melt is typically at substantially atmospheric pressure. The inside diameter of the exit tube essentially matches the diameter of the fiber bundle. A portion of the exit tube is immersed in the molten aluminum. In some embodiments, about 0.5 to about 5 cm of the tube is immersed in the molten metal. The tube is selected to be stable in the molten metal material. Examples of tubes which are typically suitable include silicon nitride and alumina tubes.

Infiltration of the molten metal into the fibers is typically enhanced by the use of ultrasonics. For example, a vibrating horn is positioned in the molten metal such that it is in close proximity to the fibers. In some embodiments, the fibers are within 2.5 mm (in some embodiments, within 1.5 mm) of the horn tip. Exemplary horn tip are made of niobium, or alloys of niobium, such as 95 wt. % Nb-5 wt. % Mo and 91 wt. % Nb-9 wt. % Mo, and can be obtained, for example, from PMTI, Pittsburgh, Pa. For additional details regarding the use of ultrasonics for making metal matrix composite articles, see, for example, U.S. Pat. No. 4,649,060 (Ishikawa et al.), U.S. Pat. No. 4,779,563 (Ishikawa et al.), and U.S. Pat. No. 4,877,643 (Ishikawa et al.), U.S. Pat. No. 6,180,232 (McCullough et al.), U.S. Pat. No. 6,245,425 (McCullough et al.), U.S. Pat. No. 6,336,495 (McCullough et al.), U.S. Pat. No. 6,329,056 (Deve et al.), U.S. Pat. No. 6,344,270 (McCullough et al.), U.S. Pat. No. 6,447,927 (McCullough et al.), and U.S. Pat. No. 6,460,597 (McCullough et al.), U.S. Pat. No. 6,485,796 (Carpenter et al.), U.S. Pat. No. 6,544,645 (McCullough et al.); U.S. application having Ser. No. 09/616,741, filed Jul. 14, 2000; and PCT application having Publication No. WO02/06550, published Jan. 24, 2002.

Typically, molten metal is degassed (e.g., reducing the amount of gas (e.g., hydrogen) dissolved in the molten metal) during and/or prior to infiltration. Techniques for degassing molten metal are well known in the metal processing art. Degassing the melt tends to reduce gas porosity in the wire. For molten aluminum the hydrogen concentration of the melt is, in some embodiments, less than 0.2, 0.15, or even less than 0.1 ml³/100 grams of aluminum.

The exit die is configured to provide the desired cross-section of the elongated metal matrix composite article. Exemplary cross-sections include circular, elliptical, polygonal (e.g., square, rectangular, triangular, or hexagonal, etc), etc. Typically, it is desired to have a uniform cross-section along the length of the elongated metal matrix composite article. The opening of the exit die is usually slightly larger than the cross-section of the elongated metal matrix composite article. For example, the diameter of a silicon nitride exit die for an elongated metal matrix composite wire containing about 50 volume percent alumina fibers is about 3 percent smaller than the diameter of the wire. In some embodiments, the exit die is made of silicon nitride, although other materials may also be useful. Other materials that have been used as exit dies in the art include conventional alumina.

In some embodiments, the elongated metal matrix composite article is cooled after exiting the exit die by contacting the article with a liquid (e.g., water) or gas (e.g., nitrogen, argon, or air). Although not wanting to be bound by theory, it is believed that such cooling aids in providing the desirable roundness, strength, and uniformity characteristics.

Elongated metal matrix composite articles can also be made, for example, by other techniques known in the art, including squeeze casting. For squeeze casting, for example, the formed substantially continuous fiber can be placed in a die (e.g., a steel die), any sizing present burned away, molten metal alloy introduced into the die cavity, and pressure applied until solidification of the cast article is complete. After cooling, the resulting elongated metal matrix composite article is removed from the die.

It is known that the presence of imperfections in the elongated metal matrix composite articles and inserts according to the present invention (e.g., intermetallic phases, dry fiber, and porosity) can result, for example, from shrinkage or internal gas (e.g., hydrogen or water vapor) voids, etc. and lead to decreases in properties such as the strength. Hence, it is desirable to reduce or minimize the presence of such characteristics.

The composition(s), shape(s) and size(s) (e.g., length, width, thickness, and diameter, as applicable), etc. of the elongated metal matrix composite articles are selected, for example, along with the particular consolidation technique to provide the desired metal matrix composite article. In some embodiments, the composition, shape and size of the elongated metal matrix composite articles are the same, while in others one or more are different. For example, to facilitate packing two or more different diameter elongated metal matrix composite wires may be used. In some embodiments, for example, some of the elongated metal matrix composite articles in the three-dimensional array may contain one type of fiber (e.g. alpha alumina fibers), while others may contain fiber of another composition. It is also within the scope of the present invention to include elongated metal articles that do not contain the substantially continuous fibers in the three-dimensional array.

The elongated metal matrix composite articles can be sized to provide the desired length. For example, the elongated metal matrix composite articles can be cut using conventional techniques such as with a wet saw or an abrasive cut-off saw.

Typically, the elongated metal matrix composite articles are cleaned prior to consolidation. Techniques for cleaning include rinsing the articles in water (e.g., deionized water) and/or organic liquids (e.g., alcohols (e.g., isopropyl alcohol)). Another exemplary cleaning liquid is a solution prepared by combining small amounts of sodium hydroxide and sodium metaphosphate in deionized water. In some embodiments, this solution is used at an elevated temperature (e.g., 45° C.-50° C.). In some embodiments, cleaning of the elongated metal matrix composite articles may include heating the articles at elevated temperatures (e.g., 70° C.-80° C.) for several minutes. In some embodiments, the elongated metal matrix composite articles are cleaned in the liquids using ultrasonics.

In some embodiments, the three dimensional array of elongated metal matrix composite articles is surrounded with at least one of metal foil (e.g., stainless steel foil (e.g., such as that available from Metal Foils, LLC, Willoughby, Ohio), copper foil (e.g., such as that available Revere Copper Products, Rome, N.Y.), and gold foil) or graphite foil (e.g., such as that available under the trade designation “GRAFOIL” from Graftech International, Wilmington, Del.). At least one of metal foil or graphite foil encloses the elongated metal matrix composite articles, holds them in a desired packing arrangement for consolidation, and provides separation between the resulting consolidated article and the consolidation die. In some embodiments, the three dimensional array of elongated metal matrix composite articles surrounded with at least one of metal foil or graphite foil is in turn enclosed in a ceramic fiber sleeve. Exemplary ceramic fiber sleeve is available, for example, under the trade designation “NEXTEL 312 CERAMIC FIBER TAPE SLEEVING” from 3M Company, St. Paul, Minn.

In some embodiments, the three dimensional array of elongated metal matrix composite articles can be consolidated by applying a combination of temperature and pressure over a period of time. For example, the elongated metal matrix composite articles can be preheated (e.g., for 10 to 120 minutes) at a temperature slightly below the solidus of the metal of the elongated metal matrix composite articles. In some embodiments, pre-heating is conducted in an inert atmosphere such as that provided by argon flowing into a muffle, wherein the elongated metal matrix composite articles have been placed. A cold pressing or diffusion bonding approach may also be useful, and typically does not include the preheating. The resulting elongated metal matrix articles can then be positioned, for example, within a die (e.g., a stainless steel die). In some embodiments, the die is preheated. For elongated metal matrix composite articles with an aluminum alloy matrix, it is typically desirable to preheat the die to a temperature between the solidus and the liquidus of the aluminum alloy. In some embodiments, the metal matrix composite articles can be preheated to a temperature just below the solidus of the metal. In some embodiments, the elongated metal matrix articles are held together to facilitate their placement in the die (e.g., with a foil such as stainless steel foil, copper foil, and gold foil). Optionally, the elongated metal matrix articles are covered with a thin metal (e.g., nickel, silver, gold, or zinc) layer over the outer surfaces of the elongated metal matrix articles. Optionally, the die is enclosed in a chamber that is evacuated of air or filled with an inert gas (e.g., argon). Pressure is applied to the die (in some embodiments in the range of 4 MPa to 30 MPa, in some embodiments, for 2 to 15 minutes; in some exemplary embodiments, for example, a pressure of 28 MPa is applied for about 5 minutes) while the die temperature is maintained.

If the elongated metal matrix article has an aluminum alloy matrix, the temperature of the die is desirably between the solidus and liquidus. Optionally, the temperature of the die may be held below the solidus of the aluminum alloy. Pressure is then released, and the resulting (consolidated) insert is removed from the die and allowed to cool to room temperature.

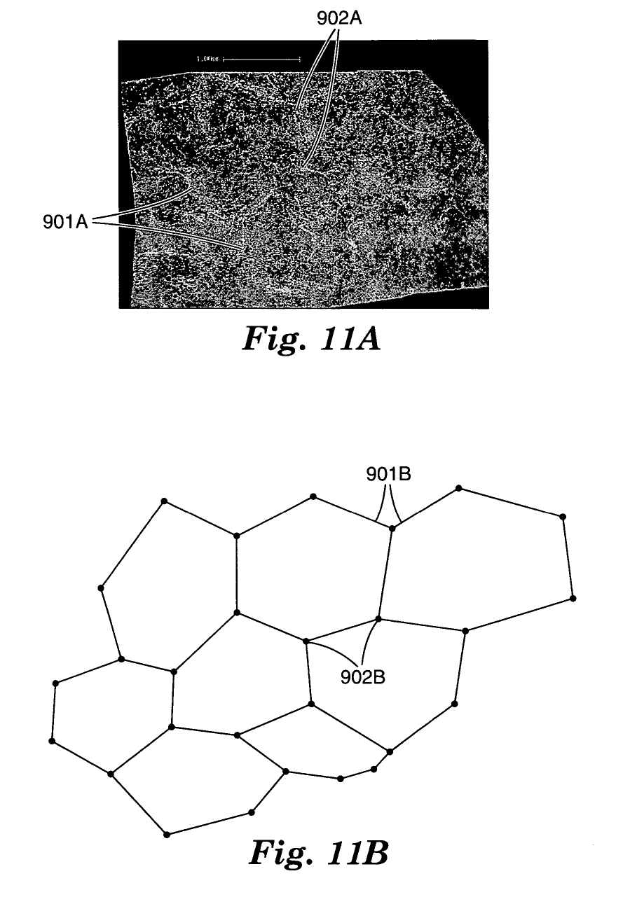

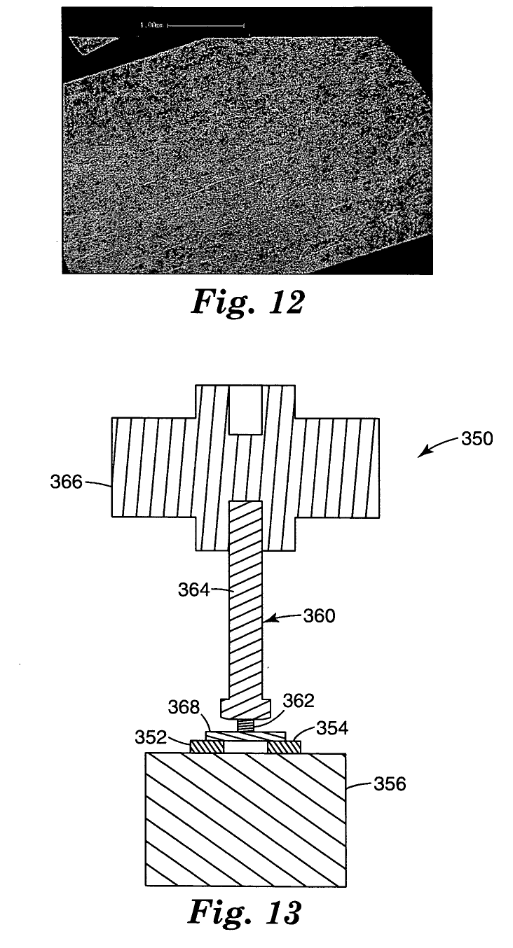

Some embodiments of metal matrix composite inserts according to the present invention include a microstructure comprising a plurality of generally polygonal (e.g., hexagonal) shapes, wherein for at least some of the generally polygonal shapes, each generally polygonal shape generally shares a common vertex with at least two adjacent generally polygonal shapes (wherein it is understood that a vertex may not necessarily be a precise point (e.g., it may be rounded)). Referring to FIG. 11B (also see FIG. 11A), a schematic of a metal matrix composite insert according to the present invention including a microstructure comprising a plurality of generally hexagonal shapes 901B (901A) is generally shown, wherein for at least some of the generally hexagonal shapes 901A (901B), each generally hexagonal shape generally shares a common vertex 902B (902A) with at least two adjacent generally hexagonal shapes.

In some embodiments, the metal matrix composite inserts have a transverse strength of at least 275 MPa, 345 MPa, 415 MPa, or even at least 475 MPa (in some embodiments, in a range from 275 MPa to 475 MPa).

The resulting metal matrix composite insert can be further processed (e.g., sand blasted and/or surface ground (e.g., with a vertical spindle diamond grinder)), for example, to remove or reduce oxidation on the surface of the insert). The metal matrix composite insert may also be cut as needed to provide a desired shape (including being cut with a water jet).

Some embodiments of metal matrix composite articles (e.g., insert) described herein are provided with a zinc layer. Techniques for providing the zinc layer include conventional techniques such as immersing the metal matrix composite article into a zinc solution. Typically, the zinc solution is either basic or acidic. Basic zinc solutions are commonly referred to as “zincate solutions”. Immersion in a basic zinc solution for about 30-50 seconds is typically sufficient to provide a desirable zinc layer. Acidic zinc solutions typically contains nitric acid, and requires slightly longer immersion times (e.g., 2-3 minutes) to provide the desired zinc layer. In both the acid and base immersion processes, the first immersion layer may be somewhat uneven. A second immersion is often desirable to achieve a more uniform layer. To facilitate the process, it is typically desirable to partially strip the zinc layer in nitric acid (50% by volume) between immersion in the zinc solution.

Some embodiments of metal matrix composite articles (e.g., inserts) described herein may be provided with a tin layer. Techniques for providing the tin layer include conventional techniques similar to those described above for zinc.

Some embodiments of metal matrix composite articles (e.g., insert) described herein are provided with a metal layer having a positive Gibbs oxidation free energy at a temperature above at least 200° C. Techniques for providing metal having a positive Gibbs oxidation free energy at a temperature above at least 200° C. are known in the art and include electroplating.

Some embodiments of metal matrix composite articles (e.g., insert) described herein are provided with a nickel layer. Although not wanting to be bound by theory, the use of nickel is believed to aid in the adhesion of metal such as Ag to the insert. Techniques for providing a nickel layer include both chemical (electroless) and electroplating methods.

The thickness of the metal having a positive Gibbs oxidation free energy at a temperature above at least 200° C., if present, is at least 8 micrometers; in some embodiments, at least 10 micrometers, at least 12 micrometers, or even at least 15 micrometers; and in some embodiments, in the range from 12 to 15 micrometers. If the thickness of the positive Gibbs oxidation free energy at a temperature above at least 200° C. is too low, the layers tend to diffuse when the insert is preheated and consequently may not protect the interface from oxidation or otherwise aid in reducing oxidation at the interface, while excess thicknesses tend to interfere with the establishment of a desirable bond strength between the metal of the insert and the metal of the metal matrix composite article.

Typically, the thickness of the nickel layer, if present, is greater than about 1 micrometer, more typically greater than 2 micrometers, or even greater than 3 micrometers. In another aspect, typically the thickness of the metal layer are less than about 10 micrometers, more typically less than about 5 micrometers. Although thicknesses outside of these values may also be useful, if the thickness is too low, the layers tend not be as useful in aiding the adhesion of the metal having a positive Gibbs oxidation free energy at a temperature above at least 200° C. to the insert, while excess thicknesses tend to interfere with the establishment of a desirable bond strength between the metal of the insert and the metal of the metal matrix composite.

Typically, the thickness of the zinc or tin layer, if present, are at least 0.2 micrometer, at least 0.3 micrometer, at least 0.4 micrometer, at least 0.5 micrometer, at least 1 micrometer, at least 1.5 micrometer, or even at least 2 micrometers; in some embodiments, in the range from 0.2 to 2 micrometers. In another aspect, typically the thickness of the metal layer are not greater than about 2 micrometers. Although thicknesses outside of these values may also be useful, if the thickness is too low, the layers tend not be as useful in aiding the adhesion of the nickel or the metal having a positive Gibbs oxidation free energy at a temperature above at least 200° C., while excess thicknesses tend to provide a less desirable composition and strength of the aluminum alloy.

Metal matrix composite articles according to the present invention can be cast using inserts according to the present invention using, in general, techniques known in the art (e.g., squeeze casting and permanent tool gravity casting). Finite Element Analysis (FEA) modeling can be used, for example, to identify optimal positions and quantities of the substantially continuous fiber for meeting desired performance specifications. Such analysis can also be used, for example, to aid in selecting the dimension(s), number, and location, for example of the inserts used. Typically, the insert(s) and/or die is preheated prior to casting. Although not wanting to be bound by theory, it is believed that preheating the insert(s) facilitates desirable metallurgical bonding between the insert(s) and the metal matrix composite articles. In some embodiments, the insert(s) is preheated to about 500° C.-600° C. In some embodiments, the die is preheated to 200° C.-500° C. Although casting can typically be conducted in air, it is also within the scope of the present invention to cast in other atmospheres (e.g., argon).

FEA, may also be used, for example, to aid in choosing a casting technique, casting conditions, and/or mold design for casting a metal matrix composite article according to the present invention. Suitable FEA software is commercially available, including that marketed by UES, Annapolis, Md., under the trade designation “PROCAST”.

As discussed above, the metal matrix composite inserts and articles are typically designed for a certain purpose, and as a result, are desired to have certain properties, to have a certain configuration, be made of certain materials, etc. Typically, the mold is selected or made to provide the desired shape of the metal matrix composite articles to be cast so as to provide a net shape or near net shape. Net-shaped or near net-shaped articles, can, for example, minimize or eliminate the need for and cost of subsequent machining or other post-casting processing of a cast metal matrix composite articles. Typically, the mold is made or adapted to hold the insert(s) in a desired location(s) such that the substantially continuous fibers are positioned in the resulting metal matrix composite articles in the desired manner. Techniques and materials for making suitable cavities are known to those skilled in the art. The material(s) from which a particular mold may be made depends, for example, on the metal used to make the metal matrix composite articles. Commonly used mold materials include graphite or steel.

Optionally, an insert holder(s) is used to hold a metal matrix composite insert(s) according to the present invention. Such insert holders can help facilitate placement of an insert(s) in the mold, which in turn facilitates placement of the insert(s) in the resulting metal matrix composite article. In one exemplary embodiment, the insert holder includes at least one portion for securing at least one metal matrix composite insert according to the present invention, wherein the insert holder comprises a metal (e.g., a metal selected from the group consisting of aluminum, alloys thereof (e.g., a 200, 300, 400, 700, and/or 6000 series aluminum alloy), and combinations thereof). In some embodiments, the insert holder has an outer surface, and a metal layer(s) is provided on the outer surface as described herein for the metal matrix composite insert.

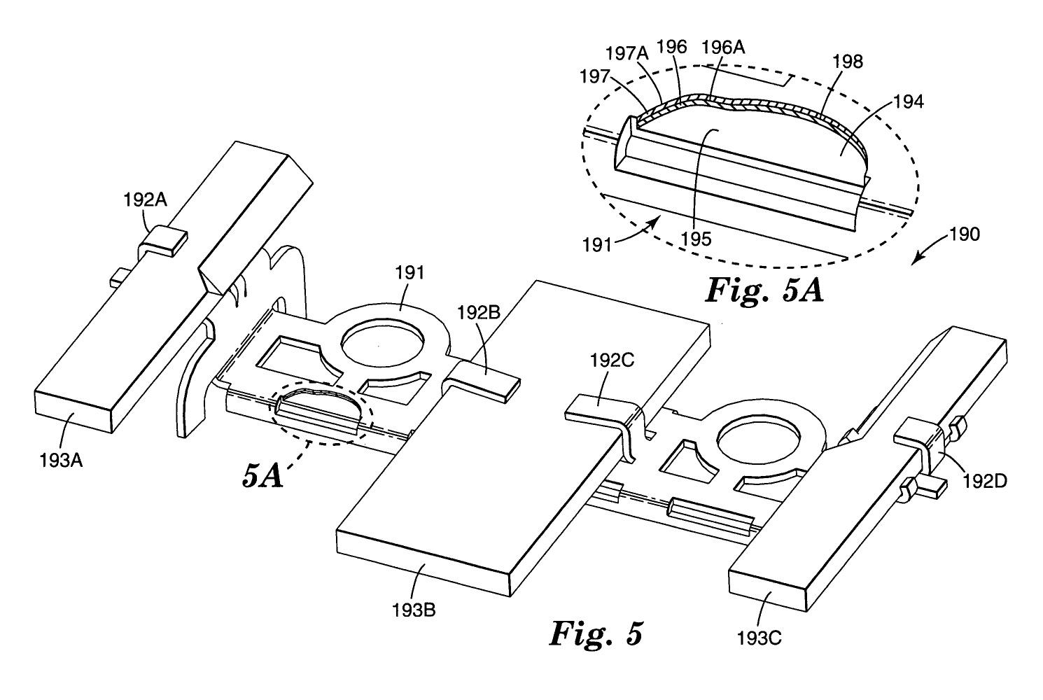

An exemplary holder with inserts positioned therein is shown in FIGS. 5 and 5A. Referring to FIG. 5, article 190 comprises holder 191 portions 192A, 192B, 192C, and 192D for securing metal matrix composite inserts according to the present invention 193A, 193B, and 193C. Referring to FIG. 5A, exemplary holder 191 comprises metal 194, outer surface 195, at least one of zinc or tin 196, outer surface 196A, nickel 197 outer surface 197A, and metal having a positive Gibbs oxidation free energy at a temperature above at least 200° C.

For additional details on exemplary insert holders see application having U.S. Ser. No. 10/403,339, filed Mar. 31, 2003.

Embodiments of metal matrix composite inserts according to the present invention can be used to make metal matrix composite articles where the inserts are molded into the composite articles. Typically, it is desirable for the molten metal in the mold operation to be in the molten state for less than 75 seconds (in some embodiments, less than 60 seconds). Although longer times for keeping the molten metal in the mold in the molten state may also be useful, the shorter times (i.e., less than 75 seconds) are generally more desirable. Although not wanting to be bound by theory, it is believed that the longer times may lead to deformation of the insert. In some embodiments, the insert does not significantly deform during the casting of a metal matrix composite article according to the present invention (i.e., the insert has a first outer dimensional configuration (i.e., size and shape) prior to casting, and a second outer dimensional shape after casting, wherein the first and second outer dimensional configurations are the same, and wherein it is understood that metal layers such as a nickel layer, tin layer, zinc layer, and/or metal layer having a positive Gibbs oxidation free energy at a temperature above at least 200° C. tend to diffuse into the metal of the casting metal (and possibly the metal of the insert)).

For metal matrix composite articles having a higher than desired amount of oxidation at the interface between the metal matrix composite insert(s) and the metal cast around the insert, the article may be further processed using hot isostatic pressing (HIPing) to reduce or remove the undesired oxidation. HIPing may also be used to reduce the porosity, if any, in the metal matrix composite article. Techniques for HIPing are well known in the art. Examples of HIPing temperatures, pressures, and times that may be useful for embodiments of the present invention include 500° C. to 600° C., 25 MPa to 50 MPa, and 4 to 6 hours, respectively. Temperatures, pressures, and times outside of these ranges may also be useful. Lower temperatures tend, for example, to provide less densification and/or increase the HIPing time, whereas higher temperatures may deform the metal matrix composite article. Lower pressures tend, for example, to provide less densification and/or increase the HIPing time, whereas higher pressures tend, for example, to be unnecessary or in some cases, may even damage the metal matrix article. Shorter times tend, for example, to provide less densification, whereas longer times may, for example, be unnecessary.

Other techniques for making metal matrix composite articles may be apparent to those skilled in the art after reviewing the instant disclosure.

Embodiments of some metal matrix composite articles according to the present invention have a “Peak Bond Strength Value” between the insert or holder, as applicable (i.e., depending on which one is being tested), and the metal cast around the insert as determined by the following “Peak Bond Strength Value Test” of at least 100 MPa (in some embodiments, at least 125 MPa, at least 150 MPa, at least 175 MPa, or even at least 180 MPa). A schematic of the compressive shear test equipment is shown in FIG. 6, wherein compressive shear test equipment 140 includes pushout tool 141, test sample 142, support block 143, and 100,000 Newton (22,482 pounds) compressive load cell 147. The metal matrix composite to be tested is cross-sectioned perpendicular to the longitudinal axis of the insert or holder, as applicable; the thickness of the cross-section for the insert is 1.16 cm (0.46 inch), the thickness of the cross-section for the holder is 0.4 cm, and the diameter of either 2.5 cm (1 inch).

Pushout tool 141 has a corresponding cross-section at the point of contact with insert or holder, as applicable, 144 within test sample 142, except the cross-sectional area of pushout tool 141 is 10 percent less (i.e., the shape of the cross-section of pushout tool 141 and insert or holder, as applicable, 144 is the same, but the size of the cross-section of pushout tool 141 is less). Pushout tool 141 is clamped in upper jaws 145 of the hydraulic chuck with a hydraulic pressure of 10.34 MPa (1500 pounds per square inch). Support block 143 has a 2.54 cm (1 inch) diameter by 0.15 cm (0.06 inch) deep counterbore. A 1.1 cm (0.435 inch) diameter through hole is placed on top of the open jaws of the lower hydraulic chuck of the test fixture.

Sample to be tested 142 is placed on top of support block 143 and nested in the counterbore for centering of the insert or holder, as applicable, over the through hole. Bottom 148 of hydraulic chuck support 146 is raised until the gap between the upper pushout tool 141, and the insert or holder, as applicable, 144 to be pushed out (i.e., sample to be tested 142), is 0.025 cm (0.01 inch). The exposed insert or holder, as applicable, 144 in the test specimen is then visually positioned with the matching tip of pushout tool 141 by manually sliding support block 143 horizontally and rotationally until the cross-sections of the two elements match.

The test is then conducted by moving the lower hydraulic support chuck up toward fixed pushout tool 141 at a rate of 0.05 cm (0.02 inch) per minute while simultaneously monitoring the load and deflection. The insert or holder, as applicable, 144 is thereby brought into contact with the fixed pushout tool face and the contact force between the two recorded as a function of displacement. The test is discontinued shortly after the peak force is reached and a total deflection of about 0.05 cm (0.02 inch) is obtained.

After completion of the test, the specimen is examined under an optical microscope at 100× magnification to verify that the test insert or holder, as applicable, and pushout tip were properly aligned such that their cross-sections were overlapping.

The average shear stress is calculated using the following formula:

$$Average Shear Stress = \frac{Load at first slippage , N ( lbs . )}{Area of contact between insert and aluminum alloy , {m}^{2} ( {in}^{2} )} .$$

The loads are plotted as a function of the insert displacement. The load at which the pushout curve has a discontinuity (i.e., where there is initial slippage at the interface between the insert or holder and the aluminum or aluminum alloy cast around the insert or holder, as applicable) is a peak bond strength value.

The Peak Bond Strength is calculated using Finite Element Analysis (FEA). Finite Element Analysis (FEA) software (available under the trade designation “ANSYS” (version 5.7) from Ansys Inc., Canonsburg, Pa.) is used to model the insert or holder, as applicable, and show that the ratio of peak bond strength to measured average shear stress is approximately 3.0.

The FEA calculation is done as follows. A finite element model of the test specimen geometry is created. The insert or holder, as applicable, is meshed with elements of dimension 0.02 cm by 0.02 cm by 0.05 cm (0.01 inch by 0.01 inch by 0.02 inch) cubes, except at the top of the insert or holder, as applicable, where the mesh size is 0.02 cm in all dimensions. The metal alloy cast around the insert or holder, as applicable, is meshed with cubes having sides of 0.05 cm (0.02 inch) near the insert or holder, as applicable, and 0.1 cm (0.04 inch) elsewhere in the modeled test specimen. The FEA software computes the shear stress at points along the surface of the insert or holder, as applicable, for an applied pressure of 533.3 MPa (corresponding to a pushout test load of 2900 pounds). The calculation determines that the peak shear stress across all points of the surface of the insert or holder, as applicable, and the average across the insert surface or holder surface, as applicable. The ratio of Peak Bond Strength to average shear stress is thus about 3 to 1.

Metal matrix composite inserts and articles according to the present invention may be in any of a variety of shapes, including a rod (including a rod having a circular, rectangular, or square cross-section), an I-beam, L-shape, or a tube. Metal matrix composite inserts and articles according to the present invention may be elongated and have a substantially constant cross-sectional area.

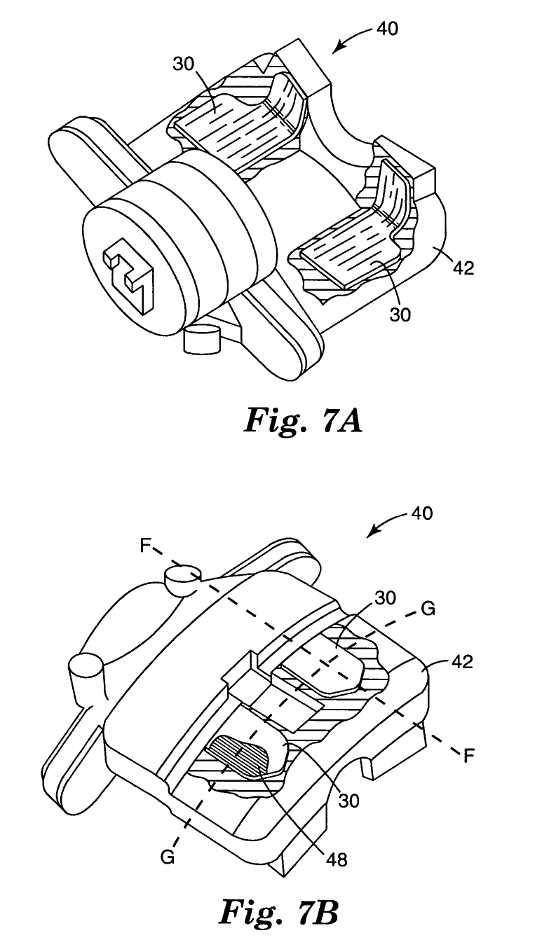

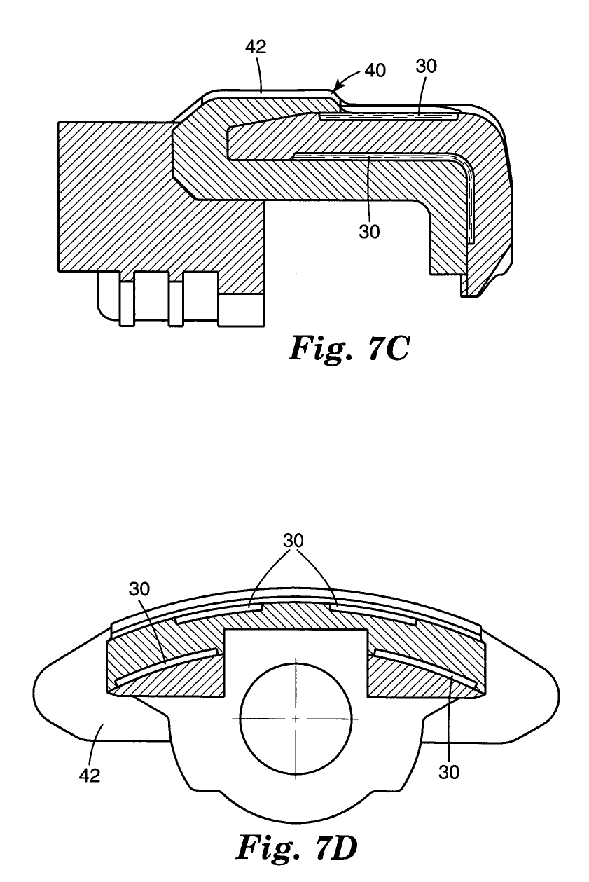

An example of such a metal matrix composite article is shown in FIGS. 7A, 7B, 7C, and 7D. Brake caliper 40 for a motor vehicle (e.g., a car, sport utility vehicle, van, or truck) comprises metal 42, and metal matrix composite inserts according to the present invention 30 (see FIG. 1) that incorporates substantially continuous (as shown longitudinally aligned) fibers 48. FIGS. 7C and 7D are cross-sectional views of FIG. 7B along lines FF and GG, respectively. In FIGS. 7C and 7D, brake caliper 40 comprises metal 42 and metal matrix composite inserts according to the present invention 30.

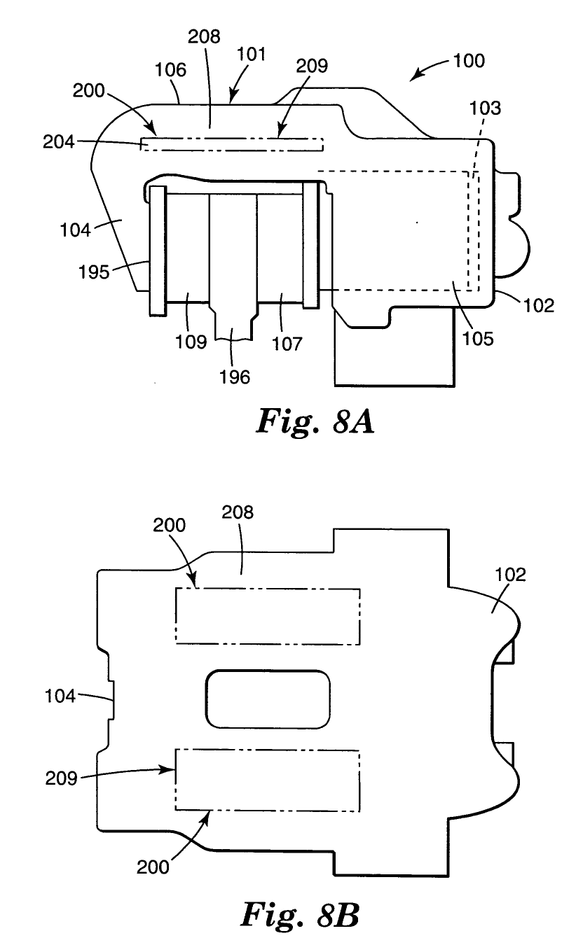

Another exemplary construction of a brake caliper incorporating a metal matrix composite insert(s) according to the present invention, as well as a brake system for a motor vehicle (e.g., a car, sports utility vehicle, van, or truck utilizing the brake caliper) is shown in FIGS. 8A and 8B. An example of a disk brake for a motor vehicle comprises a rotor; inner and outer brake pads disposed on opposite sides of the rotor and movable into braking engagement therewith; a piston for urging the inner brake pad against the rotor; and a brake caliper comprising a body member having a cylinder positioned on one side of the rotor and containing the piston, an arm member positioned on the other side of the rotor and supporting the outer brake pad, and a bridge extending between the body member and the arm member across the plane of the rotor.

Referring again to FIGS. 8A and 8B, disc brake assembly 100 comprises brake caliper housing 101 formed of body member 102, arm member 104, and bridge 106 connected at one end to body member 102 and at other end to arm member 104. Body member 102 has a generally cylindrical recess 103 therein which slideably receives piston 105 to which is pressed inner brake pad 107. Inner face 195 of arm member 104 supports outer brake pad 109 which faces inner brake pad 107. Brake rotor 196, connected to a wheel (not shown) of a vehicle, lies between inner and outer brake pads 107, 109, respectively. Metal matrix composite inserts 200 comprise metal 204. Within interfaces 209 between metal matrix composite inserts 200 and metal 208, the average amount of metal having a positive Gibbs oxidation free energy at a temperature above at least 200° C. (optionally additional metal (e.g., Ni)) is higher than in metal 208.

Hydraulic, or other, actuation of piston 105 causes inner brake pad 107 to be urged against one side of rotor 196 and, by reactive force, causes caliper housing 101 to float, thereby bringing outer brake pad 109 into engagement with the other side of rotor 196, as is well known in the art.

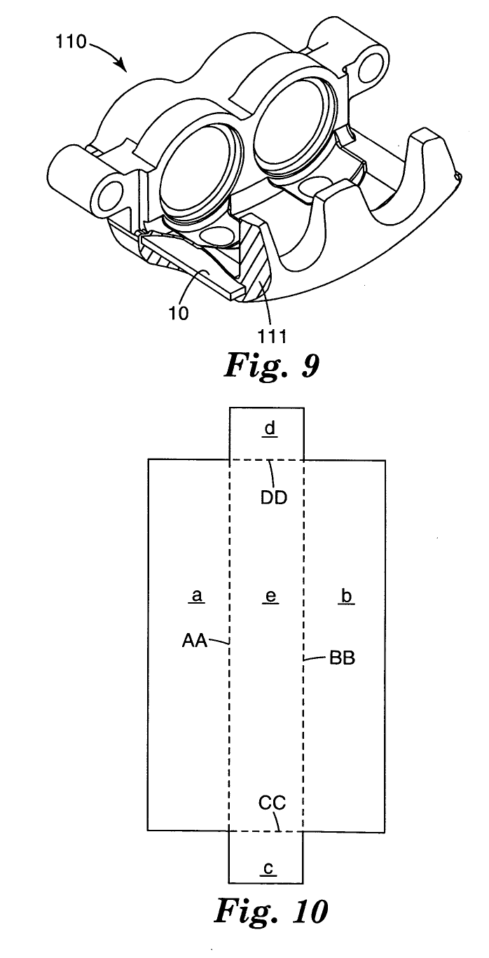

Another exemplary brake caliper according to the present invention is shown in FIG. 9, wherein brake caliper 110 comprises metal 111 and metal matrix composite insert 10.

Examples of disc brakes for using metal matrix composite brake calipers according to the present invention incorporating metal matrix composite articles according to the present invention include fixed, floating and sliding types. Additional details regarding brake calipers and brake systems can be found, for example, in U.S. Pat. No. 4,705,093 (Ogino) and U.S. Pat. No. 5,234,080 (Pantale).

Other examples of metal matrix composite articles according to the present invention which can be from metal matrix composite inserts according to the present invention include automotive components (e.g., automotive control arms and wrist pins, brake rotors, cylinder liners, electronic parking brakes, pistons, brake shoes, valve stems, brake drums, valve seats, steering knuckles, transmission housings, wheels, casings and housings, control arms, gears, steering column components, differentials, driveshafts, torque links, engine mounts, brackets, engine blocks, chassis cross beams, bearing cap ladders, side impact beams, bearing blocks, sway bars, structural oil pans, fuel rails, connecting rods, scrolls, and U-joints) and gun components (e.g., barrel support for rifled steel liner).

Advantages and embodiments of this invention are further illustrated by the following non-limiting examples, and the particular materials and amounts thereof recited in these examples, as well as other conditions and details, should not be construed to unduly limit this invention. All parts and percentages are by weight unless otherwise indicated.

### EXAMPLE

An exemplary metal matrix composite insert according to the present invention was made from 0.21 cm (0.082 inch) diameter aluminum-2% copper alloy metal matrix composite wire loaded with 60 percent by volume of tows of continuous alpha alumina fiber.

The 0.21 cm (0.082 inch) diameter aluminum-2% copper alloy metal matrix composite wire was prepared as follows. Referring to FIG. 3, seven tows of 10,000 denier alumina fibers (available from 3M Company under the trade designation “NEXTEL 610”; 10,000 denier; having Young's modulus of about 370 GPa; average longitudinal tensile strength of about 3 GPa; and average diameter of 11 micrometers) were collimated into a circular bundle. The circular bundle was heat cleaned by passing it, at a rate of 1.5 m/min., through a 1 meter tube furnace (obtained from ATS, Tulsa, Okla.), in air, at 1000° C. The circular bundle was then evacuated at less than 1 Torr by passing the bundle through an alumina entrance tube (2.7 mm in diameter, 30 cm in length; matched in diameter to the diameter of the fiber bundle) into a vacuum chamber (6 cm in diameter; 20 cm in length). The vacuum chamber was equipped with a mechanical vacuum pump having a pumping capacity of 0.4 m³/min. After exiting the vacuum chamber, the evacuated fibers entered a molten aluminum bath through an alumina tube (2.7 mm internal diameter and 25 cm in length) that was partially immersed (about 5 cm) in the molten aluminum alloy bath. The molten aluminum bath was prepared by melting aluminum alloy (98% (by weight) pure Al and 2% (by weight) Cu; obtained from Belmont Metals, Brooklyn, N.Y.) at 726° C. The molten aluminum alloy was maintained at about 726° C., and was continuously degassed by bubbling 800 cm³/min. of argon gas through a silicon carbide porous tube (obtained from Stahl Specialty Co, Kingsville, Mo.) immersed in the aluminum alloy bath. The hydrogen content of the molten aluminum alloy was measured by quenching a sample of the molten aluminum alloy in a copper crucible having a 0.64 cm×12.7 cm×7.6 cm cavity, and analyzing the resulting solidified aluminum alloy ingot for its hydrogen content using a standardized mass spectrometer test analysis (obtained from LECO Corp., St. Joseph, Mich.).

Infiltration of the molten aluminum alloy into the fiber bundle was facilitated through the use of ultrasonic infiltration. Ultrasonic vibration was provided by a wave-guide connected to an ultrasonic transducer (obtained from Sonics & Materials, Danbury Conn.). The wave guide consisted of a 91 wt % Nb-9 wt % Mo cylindrical rod, 25 mm in diameter by 90 mm in length attached with a central 10 mm screw, which was screwed to a 482 mm long, 25 mm in diameter titanium waveguide (90 wt. % Ti-6 wt. % Al-4 wt. % V). The Nb-9 wt % Mo rod was supplied by PMTI, Inc., Large, Pa. The niobium rod was positioned within 2.5 mm of the centerline of the fiber bundle. The wave-guide was operated at 20 kHz, with a 20 micrometer displacement at the tip. The fiber bundle was pulled through the molten aluminum alloy bath by a caterpuller (obtained from Tulsa Power Products, Tulsa Okla.) operating at a speed of 1.5 meter/minute.

The aluminum alloy infiltrated fiber bundle exited the crucible through a silicon nitride exit die (inside diameter 2.5 mm, outside diameter 19 mm and length 12.7 mm; obtained from Branson and Bratton Inc., Burr Ridge, Ill.). After exiting the molten aluminum alloy bath, cooling of the wire was aided with the use of a coaxial air cooling fixture. The coaxial cooling fixture delivers high velocity air at a mass flow rate of 90-120 liters per minute through a 30 cm long, 1.2 cm diameter tube. The tube is positioned 4-7 cm from the exit die. The fiber and molten metal is transported through the exit die and enters the coaxial cooling tube where the high velocity air solidifies the wire. The tubes were positioned, one on each side of the wire. The wire was then wound onto a spool. The composition of the matrix of the Example aluminum matrix wire, as determined by inductively coupled plasma analysis, was 0.01 wt. % Fe, 0.016 wt. % Nb, 0.038 wt. % Si, 0.05 wt. % Zn, 0.019 wt. % Ca, 0.026 wt. % Na, 2.18 wt. % Cu, and the balance Al. While making the wire, the hydrogen content of the aluminum bath was about 0.07 cm³/100 gm aluminum.

The wire was cut using a wet saw (obtained under the trade designation “DISCO CUTOFF MACHINE, MODEL DMU-6” from Disco Hi-Tec America Inc., Santa Clara, Calif.) with a 15.2 cm (6-inch) diameter diamond abrasive wheel (obtained from UKAM Industrial Superhard Tools, Valencia Calif.) into 50 pieces, each about 12.7 cm (5 inches) in length.

The individual pieces of wire were cleaned as follows. The pieces were first rinsed in deionized water and patted dry with paper towels. The wire pieces were then rolled on paper toweling soaked with isopropyl alcohol, and patted dry with paper towels. The wire pieces were then placed in an oven to dry at 70° C.-80° C. for about 10 minutes.

A cleaning bath was prepared by combining 8 grams of sodium hydroxide pellets, 0.9 gram of sodium metaphosphate granules, and 791 grams of deionized water. The bath was heated to 45° C.-50° C. The wire pieces were soaked in this bath for 1 minute, then rinsed in deionized water. The wire pieces were then placed in a bath of deionized water and agitated with an ultrasonic agitator (obtained under the trade designation “CAVITATOR ULTRASONIC CLEANER” from Mettler Electronic Corp., Anaheim Calif.) for 1 minute. The wire pieces were then patted dry on paper towels and dried in an oven at 40° C.-50° C. for 10 minutes.

Stainless steel foil, 321-annealed, (obtained from Metal Foils, LLC, Willoughby Ohio) of thickness 0.076 mm (0.003 inch) was cut into the pattern shown in FIG. 10. The foil was first folded along the lines AA, BB and CC so that sides a, b and c were perpendicular to the bottom e. The 50 pieces of “clean” wire pieces were placed on bottom e, aligned parallel with the long direction of the foil pattern. First sides a and b, then sides c and d were then folded flat over the wire pieces to form a rectangular bundle about 2.5 cm (1 inch) wide and 12.7 cm (5 inches) long.

The resulting bundle was then inserted into a ceramic fiber sleeve with an inside diameter of 2.5 cm (1 inch) (available under the trade designation “NEXTEL 312 CERAMIC FIBER TAPE SLEEVING” from 3M Company, St. Paul Minn.) of length about 20.3 cm (8 inches). The ends of the sleeving were tied off with a ceramic sewing thread (available under the trade designation “NEXTEL 312 CT-32 SEWING THREAD” from 3M Company, St. Paul, Minn.) to hold the packet in place within the sleeving.

The bundle/ceramic sleeve was placed in a box furnace (Model 51894, obtained from Lindberg, Watertown Wis.) that had been flushed with argon at 30 SCFH (cubic feet per hour at standard conditions) through use of a muffle. The muffle was a rectangular box with inside dimensions 2.5 by 10.2 by 19.1 cm (1 inch by 4 inches by 7.5 inches) fabricated from 13 gauge (about 0.3 cm (0.12 inch) in thickness) Inconel sheet by welding. The box was open at the front and had a port for argon gas entry at the back. A gas diffuser plate was fabricated from a 0.32 cm (0.125 inch) stainless steel sheet, with 30 uniformly spaced holes of about 0.25 cm (0.1 inch) diameter, and was mounted about 1.9 cm (0.75 inch) from the inside back surface of the box. The muffle also had a removable front door made of Inconel that had a tab allowing the door to be removed or put in place with tongs. An 2.44 m (8 foot) long serpentine tube with outer diameter 0.64 cm (0.25 inch) diameter, attached to the argon source at one end and the back of the muffle at the other end, was used to preheat the argon as the gas flowed into the furnace. The bundle was preheated at 600° C. for 30 minutes.

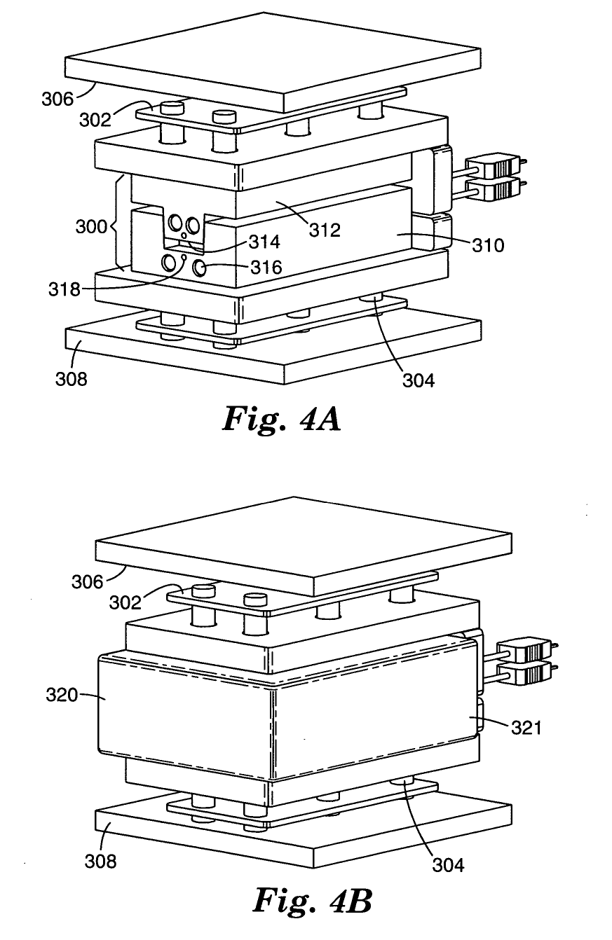

A stainless steel compaction die 300 was positioned in a 100-ton hand press (obtained from Watson-Stillman Co, Roselle N.J.) with first and second offsets 302 and 304 from the upper and lower platens 306 and 308, respectively, of the press as shown in FIGS. 4A and B. The compaction die 310 was fabricated from Grade 416 stainless steel. The bottom half of the die was 15.2 cm (6 inch) long, 7.6 cm (3 inch) long and 3.5 cm (1.38 inch) tall overall, with a cavity 2.9 cm (1.13 inch) wide and 1.9 cm (0.75 inch) deep in the top face extending over the die length, and with a 2° draft on the cavity walls. The top half of the die 312 was 15.2 cm (6 inch) long, 7.6 cm (3 inch) wide and 3.66 cm (1.44 inch) high overall, with the bottom surface 314 machined into a corresponding punch configuration. Each die half had two through holes 316 of diameter 0.95 cm (0.375 inch) for cartridge heaters, and one hole 318 0.32 cm (0.125 inch) for a thermocouple, so as to position the thermocouple bead 0.3 cm (0.12 inch) from the middle of the cavity and punch surfaces. The compaction die was coated with a boron nitride suspension (obtained under the trade designation “BORON NITRIDE LUBRICOTE ZV” from ZYP Coatings, Oak Ridge Tenn.). The die was then preheated with four cartridge heaters (obtained under the trade designation “WATLOW CARTRIDGE HEATERS, 230V/500 W” from Powermation, St. Paul Minn.) to a temperature of about 650° C. The temperature of the die was measured using Type K thermocouples (obtained under the trade designation “WATLOW/GORDON MINERAL INSULATED THERMOCOUPLE” from Powermation, St. Paul Minn.) with 15.2 cm (6 inch) sheath length. Control of the heaters was accomplished using a temperature controller (obtained from Powermation, St. Paul Minn.). The die was insulated on all sides with ceramic boards (obtained under the trade designation “SAFFIL” from Thermal Ceramics, Augusta Ga.); 1.3 cm (0.5 inch) thick ceramic boards were used on the top and bottom of the die, 1.9 cm (0.75 inch) thick ceramic boards were used on the sides, front, and back of the die. Front 320 and side boards 321 (FIG. 4B) were held inside a stainless steel frame that allowed for easy placement and removal of the insulation.

The insulating material surrounding the perimeter of the die was removed. The wire bundle as described above was removed from the muffle in the preheating furnace and transferred into the compaction die using tongs. The die was then closed and the insulating material put back into place. A load of about 89000 Newtons (10 tons) was applied to the die, and thereby to the wire bundle, for a total of 600 seconds. Less than fifteen seconds transpired between removal from the furnace and initial application of this load. The effective pressure on the wire bundle was about 24.1 MPa (3500 psi). During this time, the measured die temperature was about 650° C. The set points on the cartridge heaters in the die were then set to 570° C. and the die assembly allowed to cool to 570° C. under load.

When the die temperature reached about 570° C., pressure was released, the die was opened, and the consolidated wire bundle removed from the die and set aside to cool.

When the consolidated part was cool enough to handle, the sleeving was removed and the stainless steel foil was peeled away. The consolidated part was then allowed to cool to room temperature.

The consolidated part was trimmed to remove about 0.54 cm (0.25 inch) from each end, and the upper and lower surfaces of the part were ground using a vertical spindle diamond grinder (#11 Blanchard grinder obtained from Precision Instruments, Minneapolis, Minn.) to a thickness of 0.34 cm (0.135 inch).

Six transverse test samples of dimensions about 0.64 cm by 1.9 cm (about 0.252 inch by 0.75 inch) were cut from the consolidated part so that the long dimension of the sample was perpendicular to the long axis of the part (and thus perpendicular to the direction of the original wires). The test samples were then smoothed on both top and bottom surfaces with a 30-micrometer diamond lapping film (obtained under the trade designation “661× IMPERIAL DIAMOND LAPPING FILM SHEETS” from 3M Company, St. Paul Minn.).

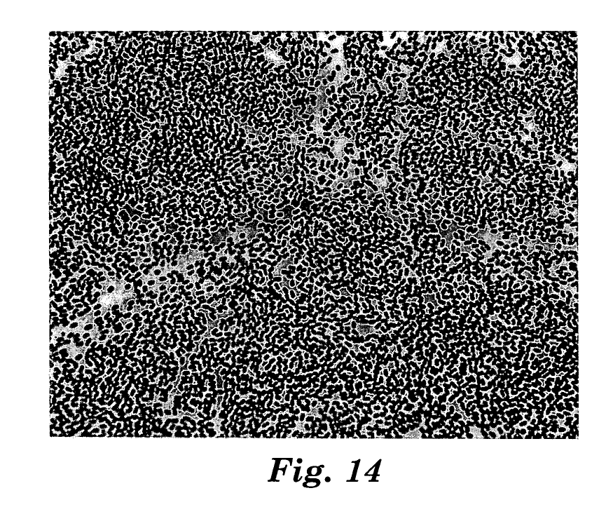

The transverse strength of the six test samples was measured by a four-point transverse bend strength test using a load frame (obtained under the trade designation “MTS/SINTECH 1/G” from MTS, Eden Prairie, Minn.) and associated software (obtained under the trade designation “TESTWORKS 4” from MTS, Eden Prairie Minn.). For transverse bend testing, a short-beam transverse bend test fixture was used. The bend test fixture was generally as shown in FIG. 13. Bend test fixture 350 had two blocks of tungsten carbide 352 and 354 bonded to base plate 356 so as to be centered over an attachment post in such a way as to give an effective load span of 1.69 cm (0.665 inch). Force was applied to the test specimen via load ram 360 and upper load anvil 362. Load ram 360 was bolt 364 held in chuck 366, with the head of bolt 364 machined to be flat and square to the shank. Upper load anvil 362 was a machined from tungsten carbide. Upper load anvil 362 was centered over the test span. Load ram 360, moving down at a speed of 0.064 mm/minute (0.025 inch/minute) was brought into contact with upper load anvil 362, and force was thereby applied to test sample 368. Force continued to be applied until the sample broke. For each sample, the peak load that the sample saw before breaking was recorded. The four-point transverse bend strength was calculated as:

$$S = \frac{P L}{W {T}^{2}} , where$$

S=bend strength, in psi
P=peak load, in pounds
L=outer span, in inches (0.665″ for this fixture)
W=specimen width, in inches
T=specimen thickness, in inches.

The results are shown in Table 1, below.

TABLE 1

| Sample | Load at failure, | Transverse strength, |
|---|---|---|
| Number | lbs. (N) (pounds) | kpsi (MPa) |
| 1 | 463.6 (2062) | 66.8 (461) |
| 2 | 415.3 (1847) | 60.3 (416) |
| 3 | 473.2 (2105) | 68.7 (474) |
| 4 | 494.2 (2198) | 71.8 (495) |
| 5 | 430.2 (1914) | 62.5 (431) |
| 6 | 419.6 (1866) | 60.9 (420) |

One cross-section of the Example sample was polished with semi-automatic metallographic grinding/polishing equipment (obtained under the trade designation “ABRAMIN” from Struers, Inc, Cleveland, Ohio). The polishing speed was 150 rpm. The polishing was done in the following successive 6 stages. The polishing force was 150 N, except in Stage 6 it was 250 N:
Stage 1
   The sample was ground for 45 seconds using 120 grit silicon carbide paper (obtained from Pace Technologies, Northbrook, Ill.) while continuously, automatically dripping water onto abrasive pad during polishing. After polishing, the sample was thoroughly rinsed with water.
Stage 2
   The sample was ground for 45 seconds using 220 grit silicon carbide paper (obtained from Pace Technologies) while continuously, automatically dripping water onto abrasive pad during polishing. After polishing, the sample was thoroughly rinsed with water.
Stage 3
   The sample was ground for 45 seconds using 600 grit silicon carbide paper (obtained from Pace Technologies) while continuously, automatically dripping water onto abrasive pad during polishing. After polishing, the sample was thoroughly rinsed with water.
Stage 4
   The sample was polished for 4.5 minutes using polishing pad (obtained under the trade designation “DP-MOL” from Struers, Inc.), wetted lightly with periodic droplets of lubricant (obtained under the trade designation “PURON, DP-LUBRICANT” from Struers) and sprayed for 1 second with 6-micrometer diamond grit (obtained under the trade designation “DP-SPRAY, P-6 μm” from Struers). After polishing, the sample was thoroughly rinsed with water.
Stage 5
   The sample was polished for 4.5 minutes using polishing pad (“DP-MOL”), wetted lightly with periodic droplets of lubricant (obtained under the trade designation “PURON, DP-LUBRICANT” from Struers) and sprayed for 1 second with 3micrometer diamond grit (obtained under the trade designation “DP-SPRAY, P-3 μm” from Struers). After polishing, the sample was thoroughly rinsed with water.
Stage 6
   The sample was polished for 4.5 minutes using a porous synthetic polishing cloth (obtained under the trade designation “OP-CHEM” from Struers), wetted first with water and a 0.5 micrometer colloidal silica suspension (obtained as “ALLIED PART NO. 180-20000” from Allied High Tech Products, Inc., Rancho Dominguez Calif.) poured by hand on the cloth. The sample was washed with water during the last 10 seconds of polishing. After polishing, the sample was dried.

The polished cross-section of the Example is shown in FIG. 11A (and at 100× in FIG. 14), illustrating a microstructure comprising a plurality of generally hexagonal shapes 901A (911), wherein for at least some of the generally hexagonal shapes 901A (901B), each generally polygonal shape generally shares a common vertex 902A (902B) with at least two adjacent generally polygonal shapes (as shown in FIG. 11B).

Metals having a positive Gibbs oxidation free energy at a temperature above at least 200° C. (e.g., silver, gold, alloys thereof, and combinations thereof), and additionally nickel, zinc and/or tin could have been provided onto the outer surface of the metal matrix composite insert, and the resulting article used to make a metal matrix composite article as discussed above in the “Summary of the Invention” and “Detailed Description” sections.

### COMPARATIVE EXAMPLE

A metal matrix composite insert was made as follows. Prepregs comprising 60 percent by volume alpha alumina fiber (available under the trade designation “NEXTEL 610” from 3M Company, St. Paul, Minn.; 10,000 denier) and 40 percent by volume resin (obtained under the trade designation “EPON 828” from Resolution Performance Products, Houston, Tex.) was made by Aldila Corp, Poway Calif. The prepreg was made in roll form, 30.5 cm (12 inches) wide. The prepregs were cut into 44 squares, each 17.8 cm (7 inches) by 17.8 cm (7 inches). The 44 squares were stacked up with the fiber directions parallel in all layers of the stack. The stack was then consolidated using an autoclave (obtained as “NATIONAL BOARD NO. 50Y2” from BROS Inc, Minneapolis, Minn.) into a rectangular block about 0.6 cm (0.24 inch) thick.

An aluminum matrix composite part was made from the perform by MER Corp., Tucson, Ariz. using a squeeze casting technique that infiltrated the perform with an aluminum-2% copper alloy.

The upper and lower surfaces of the part were ground using a vertical spindle diamond grinder (#11 Blanchard grinder obtained from Precision Instruments, Minneapolis, Minn.) to a thickness of 0.34 cm (0.135 inch).

Ten transverse test samples of dimensions about 0.64 cm by 1.9 cm (0.253 by 0.75 inch) and 0.34 cm (0.136 inch) thick were cut from the cast part so that the long dimension of the sample was perpendicular to the direction of the ceramic oxide fibers. The test samples were then smoothed on both top and bottom surfaces with a 30-micron diamond lapping film (obtained under the trade designation “661× IMPERIAL DIAMOND LAPPING FILM SHEETS” from 3M Company, St. Paul, Minn.).

The transverse strength of the ten test samples was measured by a four-point transverse bend strength test as described above in the Example. The results are shown in Table 2, below.

TABLE 2

| Sample | Load at failure, | Transverse strength, |
|---|---|---|
| Number | lbs. (N) | kpsi (MPa) |
| C-1 | 302.4 (1345) | 43.2 (298) |
| C-2 | 321.1 (1428) | 45.8 (316) |
| C-3 | 389.5 (1732) | 55.6 (383) |
| C-4 | 371.1 (1651) | 53.0 (365) |
| C-5 | 392.3 (1745) | 56.0 (386) |
| C-6 | 373.2 (1660) | 53.3 (368) |
| C-7 | 407.0 (1810) | 58.1 (401) |
| C-8 | 393.5 (1750) | 56.2 (387) |
| C-9 | 391.6 (1742) | 55.9 (385) |
| C-10 | 397.6 (1769) | 56.8 (392) |

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A method for making a metal matrix composite insert, the method comprising:
consolidating a three dimensional array of elongated metal matrix composite articles together to provide a metal matrix composite insert,
wherein at least three of the elongated metal matrix composite articles each comprise a plurality of substantially continuous fibers selected from the group consisting of boron fibers, boron nitride fibers, carbon fibers, ceramic oxide fibers, graphite fibers, silicon carbide fibers, and combinations thereof in a metal selected from the group consisting of aluminum, magnesium, and alloys thereof, wherein the metal secures the substantially continuous fibers in place, and wherein the metal extends along at least a portion of the length of the substantially continuous fibers, and
wherein the metal matrix composite insert comprises the substantially continuous fibers and metal of the elongated metal matrix composite articles, wherein such metal secures the substantially continuous fibers in place, wherein at least 50 percent by volume of the metal matrix composite insert are the substantially continuous fibers, wherein such metal extends along at least a portion of the length of the substantially continuous fibers.

2. The method according to claim 1, wherein the metal matrix composite insert has an outer surface, and wherein the method further comprises providing a metal layer onto the outer surface.

3. The method according to claim 1, wherein the metal matrix composite insert has an outer surface, and wherein the method further comprises providing at least one of a zinc or tin layer onto the outer surface.

4. The method according to claim 1, wherein the metal matrix composite insert has an outer surface, and wherein the method further comprises providing a metal layer having a positive Gibbs oxidation free energy at a temperature above at least 200° C. onto the outer surface.

5. The method according to claim 4, wherein the metal layer having a positive Gibbs oxidation free energy at a temperature above at least 200° C. has a thickness of at least 8 micrometers.

6. The method according to claim 1, wherein the metal matrix composite insert has an outer surface, and wherein the metal matrix composite insert further comprises, in order (i) at least one of a zinc or tin layer, (ii) a nickel layer, and (iii) a metal layer having a positive Gibbs oxidation free energy at a temperature above at least 200° C. onto the outer surface.

7. A method of making a metal matrix composite article, the method comprising:
positioning a metal matrix composite insert according to claim 6 in a mold;
providing molten metal selected from the group consisting of aluminum and alloys thereof into the mold; and
cooling the molten metal to provide a metal matrix composite article.

8. The method according to claim 7, wherein the plurality of substantially continuous fibers includes substantially continuous ceramic oxide fibers, and wherein the metal securing the substantially continuous ceramic oxide fibers is selected from the group consisting of aluminum and alloys thereof.

9. The method according to claim 8, wherein at least 60 percent by volume of the metal matrix composite insert are the substantially continuous ceramic oxide fibers.

10. The method according to claim 8, wherein in a range from 50 to 70 percent by volume of the metal matrix composite insert are the substantially continuous ceramic oxide fibers.

11. The method according to claim 8, wherein the metal matrix article is a vehicle component selected from the group consisting of suspension component, engine component, and structural component.

12. The method according to claim 8, wherein the metal matrix article is a brake caliper.

13. The method according to claim 7, wherein the metal matrix article is a vehicle component selected from the group consisting of suspension component, engine component, and structural component.

14. The method according to claim 7, wherein the metal matrix article is a brake caliper.

15. The method according to claim 1, wherein the plurality of substantially continuous ceramic fibers includes substantially continuous ceramic oxide fibers, and wherein the metal securing the substantially continuous ceramic oxide fibers is selected from the group consisting of aluminum and alloys thereof.

16. The method according to claim 15, wherein the metal matrix composite insert has an outer surface, and wherein the metal matrix composite insert further comprises, in order (i) at least one of a zinc or tin layer, (ii) a nickel layer, and (iii) a metal layer having a positive Gibbs oxidation free energy at a temperature above at least 200° C. onto the outer surface.

17. The method according to claim 16, wherein in a range from 50 to 70 percent by volume of the metal matrix composite insert is the substantially continuous ceramic oxide fibers.

18. The method according to claim 17, wherein the metal matrix composite insert has a transverse strength of at least 275 MPa.

19. The method according to claim 16, wherein the consolidating is conducted at a pressure less than 40 MPa.

20. The method according to claim 16, wherein the substantially continuous ceramic oxide fibers are longitudinally aligned.

21. A metal matrix composite reinforcement insert comprising:
substantially continuous fibers and a metal, wherein the metal secures the substantially continuous fibers in place, wherein at least 50 percent by volume of the metal matrix composite insert are the substantially continuous fibers, wherein the metal extends along at least a portion of the length of the substantially continuous fibers, wherein the substantially continuous fibers are selected from the group consisting of boron fibers, boron nitride fibers, carbon fibers, ceramic oxide fibers, graphite fibers, silicon carbide fibers, and combinations thereof, wherein the metal is selected from the group consisting of aluminum, magnesium, and alloys thereof, wherein the metal matrix composite reinforcement insert includes a microstructure comprising a plurality of generally polygonal shapes, and wherein for at least some of the generally polygonal shapes, each generally polygonal shape generally shares a common vertex with at least two adjacent generally polygonal shapes.

22. The metal matrix composite reinforcement insert according to claim 21, wherein the plurality of generally polygonal shapes comprises generally hexagonal shapes.

23. The metal matrix composite insert according to claim 22, wherein the metal matrix composite insert has an outer surface, and wherein the metal matrix composite insert further comprises a metal layer on the outer surface.

24. The metal matrix composite insert according to claim 22, wherein the metal matrix composite insert has an outer surface, and wherein the metal matrix composite insert further comprises at least one of a zinc or tin layer on the outer surface.

25. The metal matrix composite insert according to claim 22, wherein the metal matrix composite insert has an outer surface and further comprises a metal layer on the outer surface, and wherein the metal layer has a positive Gibbs oxidation free energy at a temperature above at least 200° C.

26. The metal matrix composite insert according to claim 25, wherein the metal layer has a thickness of at least 8 micrometers.

27. The metal matrix composite insert according to claim 22, wherein the metal matrix composite insert has an outer surface, and wherein the metal matrix composite insert further comprises, in order (i) at least one of a zinc or tin layer, (ii) a nickel layer, and (iii) a metal later having a positive Gibbs oxidation free energy at a temperature above at least 200° C. onto the outer surface.

28. The metal matrix composite insert according to claim 27, wherein the plurality of substantially continuous fibers includes substantially continuous ceramic oxide fibers, and wherein the metal securing the substantially continuous ceramic oxide fibers is selected from the group consisting of aluminum and alloys thereof.

29. The metal matrix composite insert according to claim 28, wherein at least 60 percent by volume of the metal matrix composite insert is the substantially continuous ceramic oxide fibers.

30. The metal matrix composite insert according to claim 28, wherein in a range from 50 to 70 percent by volume of the metal matrix composite insert is the substantially continuous ceramic oxide fibers.

31. The metal matrix composite insert according to claim 28, wherein the metal matrix composite insert has a transverse strength of at least 275 MPa.

32. The metal matrix composite insert according to claim 22, wherein the plurality of substantially continuous fibers includes substantially continuous ceramic oxide fibers, and wherein the metal securing the substantially continuous ceramic oxide fibers is selected from the group consisting of aluminum and alloys thereof.

33. The metal matrix composite insert according to claim 32, wherein the substantially continuous ceramic oxide fibers are longitudinally aligned.
